(19) United States
(12) Patent Application Publication
(10) Pub. No.: US 2003/0055992 A1
(43) Pub. Date: Mar. 20, 2003

(54) Method and system for providing remote land-line access to customer premises equipment

(75) Inventor: Robert J. Miller, Raleigh, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 10/064,728

(22) Filed: Aug. 9, 2002

Related U.S. Application Data
(60) Provisional application No. 60/310,837, filed on Aug. 9, 2001.

(51) Int. Cl. G06F 15/16

(52) U.S. Cl. 709/229

(57) ABSTRACT

A method and system is disclosed for providing land-line access to customer premises equipment devices. In particular, a system and method is provided including at least one computer network service provider. A customer premises equipment device is operatively connected to the at least one service provider over a computer network, with the customer premises equipment device being configured to include a broadband modem and an analog modem. A computer is then operatively connected to the customer premises equipment device for obtaining access to the computer network through the customer premises equipment device. In accordance with the present invention, the at least one service provider may monitor and configure the customer premises equipment device by exchanging information with the analog modem, thus enabling the service providers to access and remotely monitor and configure the CPE device to meet various required protocols.

### CROSS REFERENCE TO RELATED APPLICATIONS

The present application hereby claims priority to co-pending U.S. Provisional Patent Application No. 60/310,837 filed on Aug. 9, 2001, the entirety of which is hereby incorporated by reference herein.

### BACKGROUND OF THE INVENTION

The present invention relates generally to communication systems and, more particularly, to systems for remotely configuring and diagnosing customer premises equipment (CPE) devices associated with such communications systems.

Customer Premises Equipment (CPE) devices comprise a wide variety of equipment typically purchased or leased by a consumer for use with a variety of different service providers. For example, an asymmetrical digital subscriber line (ADSL) modem may be manufactured by company A, marketed and distributed by company B, and be supported by a variety of individual internet service providers (ISP's). Each ISP however, in turn, prior to providing the customer with the services offered, must also deal with a customer local ADSL service provider, which provides the intermediate service to both the CPE and ISP ends. Additionally, each of the service providers, both the ISP as well as the local ADSL service provider, may have their own unique configuration requirements for the CPE device. It should be understood that although ADSL is specifically referenced in the above example, any suitable CPE device may be configured in accordance with the present invention.

Unfortunately, although the customer has purchased the equipment with the understanding that it will operate within his set of circumstances, in non-retail markets, there may be situations where the intermediate service providers each require their own unique configuration for the CPE device. Further, a terminating service provider (i.e., the ISP) must also maintain inventory of each CPE device and track update requests by the intermediate provider(s).

In retail markets, when a customer purchases a CPE device at a local electronics store. The customer follows the physical install directions, connecting the CPE device to their home or office computer or network, and is ready to establish a data link to an ISP of choice. There are however, possibly one or more intermediate providers are involved which aid in the service delivery, each with a possible unique configuration requirement.

In an alternative scenario, a customer has self-installed a CPE device and is unable to gain access to the terminating provider's ISP service. As above, this problem may result from the existence of one or more intermediate service providers involved in establishing the data link between the CPE and the ISP, making it difficult to determine which area of the link is malfunctioning. Additionally, changes in the topology of the intermediate providers, render static procedures unusable, and may result in lengthy Technical Support Calls or possible truck rolls to the CP.

Unfortunately, conventional CPE devices fail to provide for solutions to the above problems, resulting in lengthy installation times and possibly resulting in interruption of service to the CPE device due to changes in the topology of the service providers.

Accordingly, there is a need for a CPE device and associated communications system which enables dynamic configuration and monitoring of the CPE device.

### SUMMARY OF THE INVENTION

The present invention overcomes the problems noted above, and realizes additional advantages, by providing a method and system for providing land-line access to these CPE devices, thus enabling intermediate and terminating providers to access and remotely configure the CPE device to meet the various required protocols. In particular, a system and method is provided including at least one computer network service provider. A customer premises equipment device is operatively connected to the at least one service provider over the computer network. A computer is then operatively connected to the customer premises equipment device. The customer premises equipment device is configured to include a broadband modem and an analog modem and the at least one service provider may monitor and configure the customer premises equipment device by exchanging information with the analog modem.

### BRIEF DESCRIPTION OF THE DRAWINGS

The preceding brief description of the invention of the invention may be more fully understood in combination with the following Detailed Description of the Preferred Embodiments and the following figures.

FIG. 1 is a block diagram illustrating a communications system incorporating the remote land-line access system of the present invention.

FIG. 2 is a flow diagram illustrating one embodiment of a method for utilizing remote access to a CPE device in accordance with the present invention.

FIG. 3 is a flow diagram illustrating a second embodiment of a method for utilizing remote access to a CPE device in accordance with the present invention.

FIG. 4 is a flow diagram illustrating another embodiment of a method for utilizing remote access to a CPE device in accordance with the present invention.

### DETAILED DESCRIPTION OF THE PREFERRED EMBODIMENTS

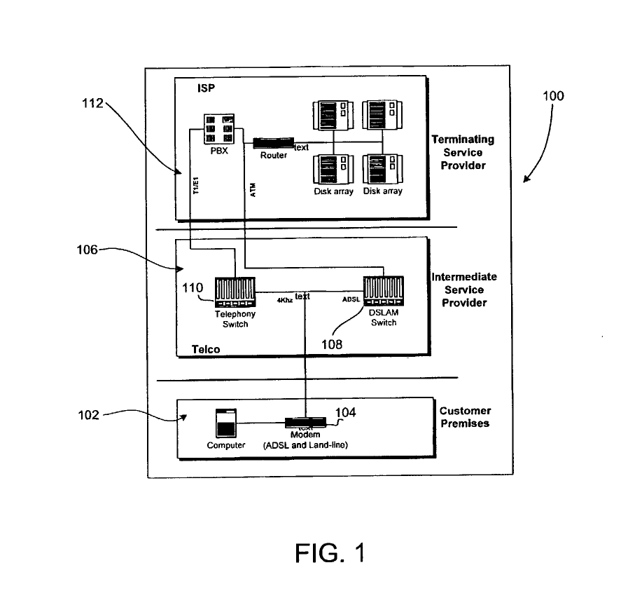

Referring now to FIG. 1, there is shown a block diagram illustrating a communications system 100 incorporating the remote land-line access system of the present invention. In particular, system 100 includes three distinct levels of operation. A CPE level 102 includes the CPE device 104 as well as any equipment connected to the device such as a computer or the like. In accordance with one embodiment of the present invention, in addition to a broadband modem for receiving and transmitting digital xDSL signals, the CPE device 104 also includes an analog modem for receiving and transmitting analog POTS-based signals. In accordance with the present invention, the xDSL and analog modems may be configured to share a single physical link and further be configured to enable status information regarding the CPE to device to be shared therebetween. The utility and functionality of this analog modem will be described in detail below.

Returning now to FIG. 1, an Intermediate Service Provider level 106 relates to the local provider (e.g., the telephone carrier) described briefly above. Level 106 typically includes at least a data switch 108 and a telephony switch 110 for routing data and voice traffic to appropriate elements of the Termination Service Provider. A Terminating Service Provider level 112 relates to the ISP contracted to provide service to the customer. Level 112 is connected to level 106 and typically includes a private branch exchange 114, a router 116, and a plurality of disk arrays 118 for storing address information used by the router.

Each of the levels 102, 106 and 112 are connected via conventional networks using known technology such as the public switched telephone network (PSTN), T1/E1, asynchronous transfer mode, etc. Additionally, in accordance with one embodiment of the present invention, the Intermediate Service Provider level 106 is connected to the CPE device 104 through both ADSL (or similar technology) as well as a land-line connection based upon POTS (plain old telephone system). In the instance of ADSL and other forms of DSL technology, both the ADSL and POTS connections may optionally be made utilizing a single RJ-11 connector to a single existing phone line, with distinctions between the two modems being made entirely internally.

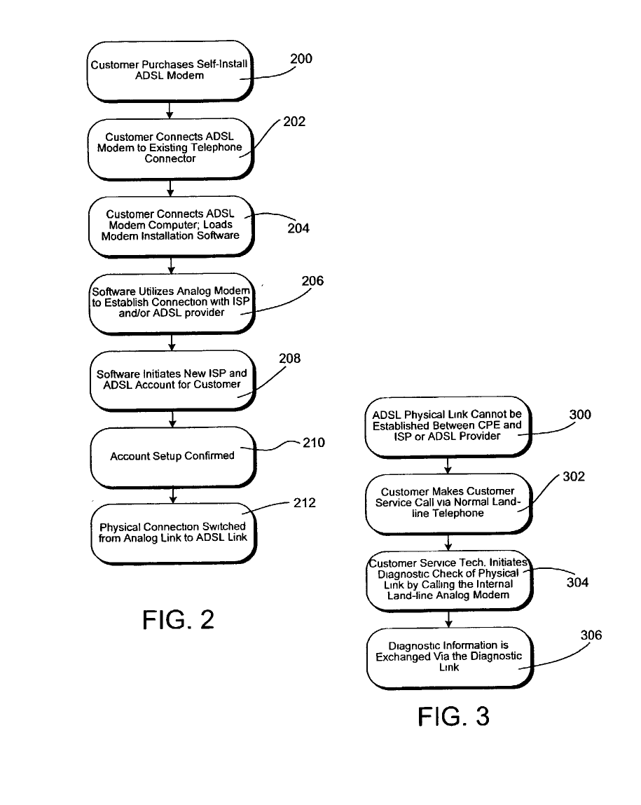

Referring now to FIG. 2, there is shown a flow diagram illustrating one embodiment of a method for utilizing the land-line connection of the present invention. In step 200, a customer purchases a self-install ADSL modem from a generic electronics provider. Next, in step 202, the customer connects the ADSL modem to an existing telephone connector as required by the modem's installation instructions. In some instances, this may result in the disconnecting of any existing conventional V.90 modems in which the ADSL modem is to replace. Next, in step 204, the customer connects the modem to the computer it is to provide access for and loads the modem installation software. In step 206, the installed software then utilizes the analog modem contained within the ADSL modem to establish a connection to the ISP and/or the ADSL provider, through the choice of location or ZIP code being provided by customer. During this step, specific information regarding the ADSL modem's identification (e.g., its MAC address, etc.) and status may be transmitted using the analog modem. In step 208, the software then initiates a new ISP and ADSL account for the customer. In step 210, the account setup is confirmed and, in step 212, the installation software retrieves specific configuration information from the ISP or ADSL provider, such as IP address, route/bridge settings, and ATM VCI/VPI settings. These settings are then used to configuration the CPE modem accordingly in step 214. Finally, in step 216, the physical connection is switched from the analog link to the ADSL link. By providing internal hardware and supportive software, the present invention enables customers to configure and set-up an ADSL modem without outside intervention.

Now referring to FIG. 3, there is shown a second embodiment of a method for utilizing the land-line connection of the present invention. In particular, in step 300, an ADSL physical link cannot be established between an ISP or ADSL service provider and the customer's CPE device. In step 302, the customer makes a customer service call via his normal land-line telephone. Next, in step 304, the customer service technician then initiates a diagnostic check of the physical link by making a dial-in call to the ADSL modem's internal land-line analog modem. Diagnostic information pertaining to the ADSL physical parameters are then exchanged via this diagnostic link in step 306, which provides the customer service technician with information necessary to ascertain the status of the ADSL link, including the potential cause of any disruption.

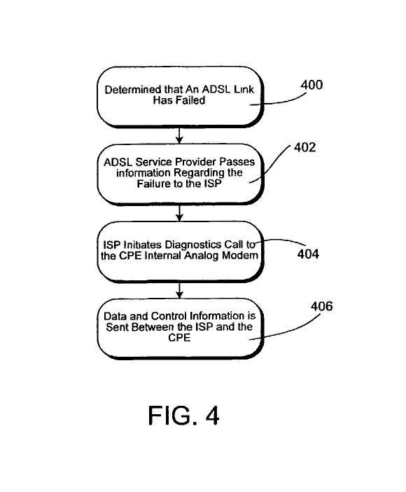

Referring now to FIG. 4, there is next shown a third embodiment of a method for utilizing the land-line connection of the present invention. In step 400, it is determined that an ADSL link has failed, but that the physical link between the service provider(s) and the CPE device have been confirmed as being established. This knowledge then allows the ADSL service provider to pass information regarding the failure to the ISP, which is the ADSL link layer provider, in step 402. In response the ISP initiates another diagnostics call to the CPE internal analog modem in step 404. However, unlike the method set forth above, the ISP now exchanges information relating to the status of the data (or link) layer, rather than the physical layer. In step 406, data and control information is sent between the ISP and the CPE, which carry diagnostic control and data information about the CPE to ISP link, as well as CPE to host (customer) computer system. Using this information, the ISP is able to accurately determine the cause of the failure and whether the problem lies with the CPE device or with other off-premises configurations or equipment. Details of the diagnostics information and format may be specific for a particular type of ADSL modem and ISP/ADSL provider, and as such is outside the scope of the present invention. Similarly, data control information exchanged may be proprietary or may be IP based.

By providing land-line access to these CPE devices, intermediate and terminating providers can access, and remote configure the CPE device itself without requiring action on the part of the customer. Land-line (i.e., POTS) support is ubiquitous around the world, thereby ensuring successful deployment to customer's premises. Further, a low-speed land-line connection, allows for reliable automated low-cost implementations to be developed. Through the usage of Service Provider maintained automation routines, each provider is able to track internal changes to infrastructure and network topologies without the usual restrictions encountered in publicly released products.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A system for providing remote land-line access to a customer premises equipment device, comprising:
at least one computer network service provider;
a customer premises equipment device operatively connected to the at least one service provider over the computer network; and
a computer operatively connected to the customer premises equipment device,
wherein the customer premises equipment device includes a broadband modem and an analog modem and wherein the at least one service provider may monitor and configure the customer premises equipment device by exchanging information with the analog modem.

2. The system of claim 1, wherein the at least one service provider includes each of a terminating service provider and an intermediate service provider operatively connected to the terminating service provider over a computer network, and wherein the customer premises equipment device is operatively connected to the intermediate service provider.

3. The system of claim 2, wherein the terminating service provider is an internet service provider and the intermediate service provider is an ADSL service provider.

4. The system of claim 1, wherein the customer premises equipment is an ADSL modem.

5. The system of claim 1, wherein physical link diagnostic information is exchanged between the service provider and the analog modem.

6. The system of claim 1, wherein ADSL layer information is exchanged between the service provider and the analog modem.

7. The system of claim 1, wherein account setup and broadband modem configuration information are exchanged between the service provider and the analog modem.

8. A method for providing remote land-line access to a customer premises equipment device, comprising the steps of:
configuring a customer premises equipment to include at least a broadband modem and an analog modem; and
operatively connecting the customer premises equipment to at least one service provider,
wherein the at least one service provider may monitor and configure the customer premises equipment device by exchanging information with the analog modem.

9. The method of claim 8, wherein the at least one service provider includes each of a terminating service provider and an intermediate service provider operatively connected to the terminating service provider over a computer network, and wherein the customer premises equipment device is operatively connected to the intermediate service provider.

10. The method of claim 9, wherein the terminating service provider is an internet service provider and the intermediate service provider is an ADSL service provider.

11. The method of claim 8, wherein the customer premises equipment is an ADSL modem.

12. The method of claim 8, further comprising the step of exchanging physical link diagnostic information between the service provider and the analog modem over the computer network.

13. The method of claim 8, further comprising the step of exchanging ADSL layer information between the service provider and the analog modem over the computer network.

14. The method of claim 8, further comprising the step of exchanging account setup and broadband modem configuration information between the service provider and the analog modem over the computer network.
